(19) United States
(12) Patent Application Publication
(10) Pub. No.: US 2005/0062386 A1
(43) Pub. Date: Mar. 24, 2005

(54) Spark plug

(76) Inventors: Christian Francesconi, Bruck a.d. Mur (AT); Christoph Egger, Jenbach (AT)

Correspondence Address: Mark D. Lorusso;Lorusso, Loud & Kelly LLP, Suite 312, 15 Rye Street, Portsmouth, NH, 03801, US

(21) Appl. No.: 10/945,821

(22) Filed: Sep. 20, 2004

(30) Foreign Application Priority Data
Sep. 19, 2003 (AT) A 1485/2003

(51) Int. Cl. H01T 13/20; H01T 21/02

(52) U.S. Cl. 313/143; 313/141; 313/142; 445/7

(57) ABSTRACT

A spark plug, in particular for use in internal combustion engines, comprising a spark plug casing (2) and a ground electrode carrier casing (3) wherein the ground electrode carrier casing (3) has at least two ground electrode carrier casing portions (3′, 3″) having mutually different materials and/or the ground electrode carrier casing (3) is of a different material from the spark plug casing (2).

The present invention concerns a spark plug, in particular for use in internal combustion engines, comprising a spark plug casing and a ground electrode carrier casing, as well as a process for the production of such a spark plug.

The spark plugs which are known in the state of the art have a ground electrode carrier casing with which the spark plug is inserted for example into the cylinder head of an internal combustion engine. In most cases the ground electrode carrier casing is provided at its outside surface with a screwthread with which the spark plug can be screwed into the cylinder head. However, spark plugs with smooth cylindrical ground electrode carrier casings are also known, which are clamped into the cylinder head or which are fixed thereto for example by means of a bayonet fixing. One or more ground electrodes are provided at the combustion chamber end of the ground electrode carrier casing. The ground electrode carrier casing itself is made in one piece with the rest of the spark plug casing or is welded thereto by means of resistance welding methods. In the case of the spark plugs known in the state of the art, the combustion chamber end of the ground electrode carrier casing frequently involves problems with the extremely high temperatures there. The situation repeatedly involves hot corrosion in the region of the ground electrode carrier casing and thus gives rise to adverse impairment or destruction of the spark plug.

Therefore the object of the invention is to provide a spark plug in which hot corrosion of the ground electrode carrier casing is prevented. In accordance with the invention that is achieved in that the ground electrode carrier casing has at least two ground electrode carrier casing portions having mutually different materials and/or the ground electrode carrier casing is of a different material from the spark plug casing.

In accordance with the invention, provided in the region in which the greatest production of heat occurs at the ground electrode carrier casing is a special material which effectively prevents hot corrosion. In that case the remaining structure of the spark plug can be of the previously known form and can be implemented using the materials which are also hitherto usual, and thus generally inexpensively. In that respect there is the option of making both a part of the ground electrode carrier casing and also the entire ground electrode carrier casing from a different material from the spark plug casing or the other part, which has remained thereon, of the ground electrode carrier casing.

A suitable process for the production of a spark plug according to the invention provides that the ground electrode carrier casing is provided with at least two ground electrode carrier casing portions, wherein they are of different materials and/or the ground electrode carrier casing is made from a different material from the spark plug casing. In a particularly inexpensive fashion a spark plug according to the invention can be produced starting from a commercially available spark plug if on a commercially available spark plug comprising a ground electrode carrier casing at the end thereof which in the position of installation faces towards a combustion chamber a part of the ground electrode carrier casing or the entire ground electrode carrier casing and possibly the ground electrode or ground electrode arrangement present there is removed and then a ground electrode carrier ring is fitted onto or welded to the remaining part of the ground electrode carrier casing or the spark plug casing of the commercially available spark plug, wherein the ground electrode carrier ring is of a different material from the remaining part of the ground electrode carrier casing or the spark plug casing of the commercially available spark plug.

Further details and features of the present invention will be apparent from the specific description hereinafter. In the drawing:

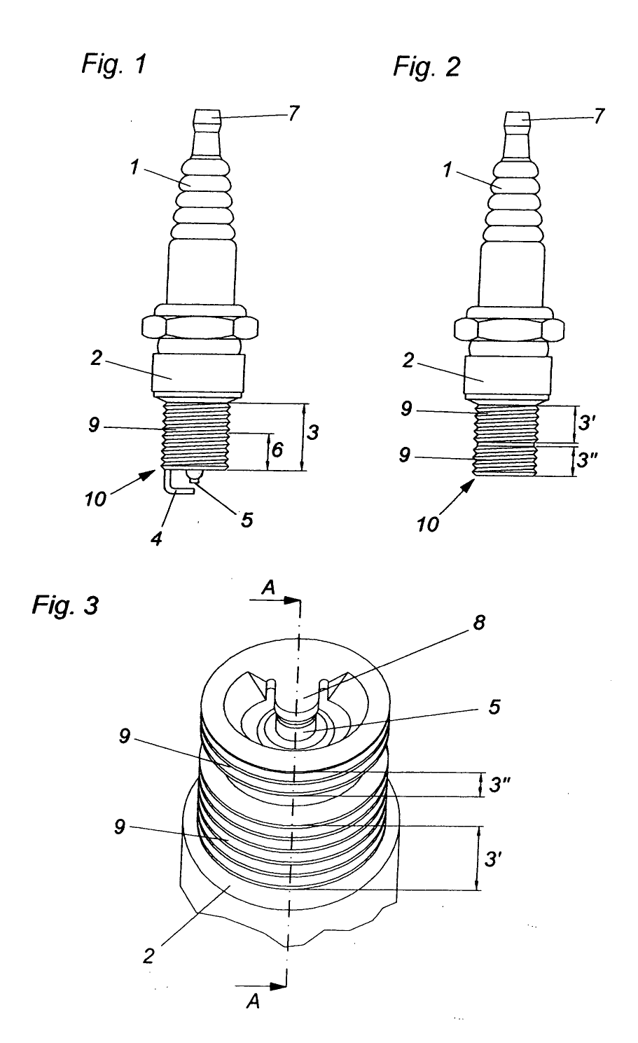

FIG. 1 shows a spark plug in accordance with the state of the art,

FIG. 2 shows a variant in accordance with the invention of a spark plug,

FIG. 3 shows a perspective view of the combustion chamber end of the spark plug according to the invention shown in FIG. 2 in a first embodiment,

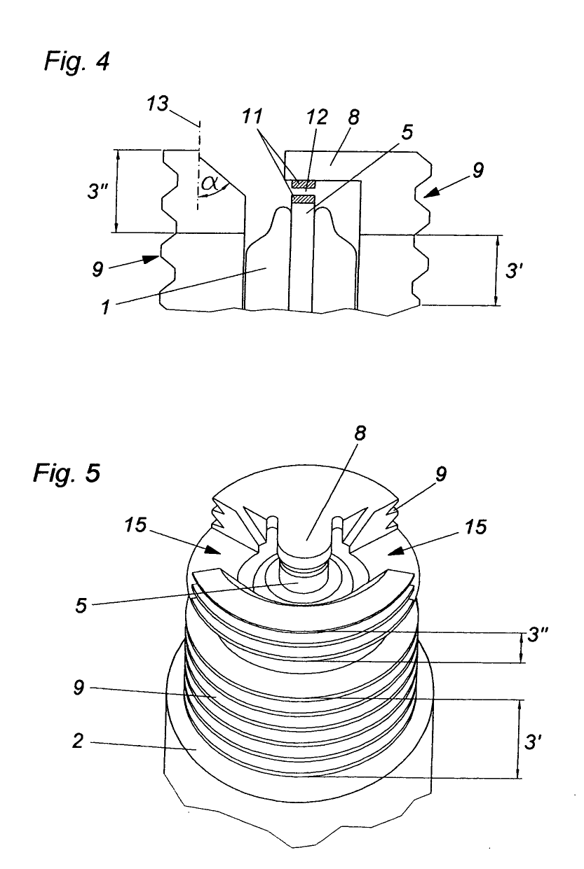

FIG. 4 shows a view in section through the upper part of the ground electrode carrier casing as shown in FIG. 3 taken along section line AA, and

FIG. 5 shows a perspective view of a further variant of the combustion chamber end of a spark plug according to the invention.

In the state of the art shown in FIG. 1 the spark plug has an insulator body 1 and a spark plug casing 2 enclosing same. The ground electrode carrier casing 3 is generally connected integrally or by resistance welding to the spark plug casing 2. In the commercially available standard spark plug shown in FIG. 1 the ground electrode carrier casing 3 carries the screwthread 9 with which the spark plug is screwed for example into the cylinder head of an internal combustion engine. Arranged at the end 10 of the ground electrode carrier casing 3, which at the combustion chamber side or which faces towards the combustion chamber, is a hook electrode 4 as the ground electrode. In opposite relationship to the end of the hook electrode 4 the central electrode 5 projects out the insulator body 1. The connecting contact 7 is provided for connecting the central electrode 5 which is guided in the insulator body 1, to an ignition plug (not shown).

While in the state of the art the ground electrode carrier casing 3 together with the spark plug casing 2 is made from one and the same material, a first variant of the present invention, as FIG. 2 shows, provides at least two different ground electrode carrier casing portions 3′ and 3″ which have mutually different material. In the illustrated embodiment both ground electrode carrier casing portions 3′ and 3″ carry a screwthread 9. It is however also possible for only one portion 3′ or 3″ or no portion to carry a screwthread 9. In the illustrated case the spacing between the two portions 3′ and 3″ is so selected that both portions can be screwed together into a standard screwthread. In order to prevent hot corrosion the ground electrode carrier casing portion 3″ which faces towards the combustion chamber desirably involves a higher level of thermal conductivity than the other ground electrode carrier casing portion 3′, whereby the heat which occurs at the combustion chamber end 10 can be quickly dissipated. In the illustrated embodiment the ground electrode carrier casing portion 3″ at the combustion chamber side is in the form of a ring fitted onto or welded to the other ground electrode carrier casing portion 3′. An advantageous process for that purpose provides that, taking the commercially available standard spark plug as shown in FIG. 1, firstly the region 6 of the ground electrode carrier casing 3 together with the ground electrode 4 is removed therefrom and then the ground electrode carrier ring 3″ of a different material is fitted onto the ground electrode carrier casing portion 3′ which has remained in the commercially available spark plug and is desirably welded thereto. In a second variant according to the invention the entire ground electrode carrier casing 3 comprises a different material from the spark plug casing 2. In a production process which is otherwise similar to the above-depicted process, then not only a part of the ground electrode carrier casing 3 but the entire ground electrode carrier casing 3 of the standard spark plug is removed and replaced by a ground electrode carrier ring 3″ of different material. That is again welded to the spark plug casing 2. In both variants the pulsed or unpulsed laser welding process is a preferred welding process.

The ground electrode carrier casing portion 3″ which in the position of installation of the spark plug faces towards a combustion chamber carries a ground electrode 8 or a ground electrode carrier arrangement. In that respect a spark plug which is particularly operationally resistant is achieved if the ground electrode 8 or the ground electrode arrangement is arranged substantially in the interior of the ground electrode carrier casing portion 3″ or the ground electrode carrier casing 3, which in the position of installation of the spark plug faces towards a combustion chamber. That is shown by way of example in FIG. 3. In that case, the integrated ground electrode 8 is disposed in the interior of the portion 3″, it is desirably made from the same material as the portion 3″ and can be made in one piece therewith. The screwthread 9 or the wall of the ground electrode carrier casing 3 or its portion 3″ which is towards the combustion chamber desirably projects beyond the spark location 12 (see FIG. 4). In particular making the ground electrode 8 in one piece with the ground electrode carrier casing 3 or its portion 3″ towards the combustion chamber provides for optimum heat dissipation from the immediate ignition location into the mounting means of the spark plug (for example the screwthread of a cylinder head).

As is known per se, the central electrode 5 and/or the ground electrode 8 can carry a small electrode plate portion 11, preferably of noble metal, as the electrode. It is particularly advantageous if the ground electrode carrier casing portion 3″ which is towards the combustion chamber or the entire ground electrode carrier casing 3 has a nickel-base alloy or a nickel-chromium alloy, wherein besides nickel and chromium it may also include at least one of the elements aluminum, titanium, niobium, cobalt, copper, molybdenum, tungsten or iron. A particularly preferred nickel-base alloy is the material marketed under the trade name “Inco Alloy 600” * No: 2.4816. The spark plug casing 2 and the portion 3′ which is optionally present of the ground electrode carrier casing 3 can be made from the hitherto usual, generally less expensive materials.

FIG. 4 shows a section taken along line AA through the combustion chamber end of the ground electrode carrier casing 3. Besides the integral configuration of the ground electrode 8 with the portion 3″ as already discussed above, and the provision of small electrode plate portions 11 (preferably of noble metal), accessibility of the mixture to the spark location is improved by the wall, which surrounds the ground electrode 8, of the portion 3″ or the ground electrode carrier casing 3 being inclined at least in a region-wise manner towards the ground electrode 8 at an angle of between 10° and 60° relative to a line 13 parallel to the central electrode 5 of the spark plug. Angles of inclination of about 30° are preferred in the sense of affording particularly optimum accessibility for the mixture to the spark location 12.

A further improvement in accessibility of the mixture to the spark location 12 is achieved as shown by way of example in FIG. 5 by means of recesses 15 at the combustion chamber end of the portion 3″ or the ground electrode carrier casing 3.

Even if in the illustrated embodiments by way of example the ground electrode carrier casing 3 and the portions 3′ and 3″ thereof each carry a respective screwthread 9, the invention is not restricted to such spark plugs. The invention can also be embodied in relation to spark plugs in which the ground electrode carrier casing 3 does not have a screwthread 9 and/or is of a different configuration. In addition the most widely varying ground electrode configurations are possible. Besides the illustrated two portions 3′ and 3″ the ground electrode carrier casing 3 may also have further portions with once again other materials.

1. A spark plug comprising a spark plug casing and a ground electrode carrier casing characterized in that the ground electrode carrier casing has at least two ground electrode carrier casing portions having mutually different materials or the ground electrode carrier casing is of a different material from the spark plug casing.

2. A spark plug as set forth in claim 1 characterized in that at least one ground electrode carrier casing portion has a screwthread.

3. A spark plug as set forth in claim 1 characterized in that the ground electrode carrier casing portion which in the position of installation of the spark plug faces towards a combustion chamber is of higher thermal conductivity than the other ground electrode carrier casing portion or portions.

4. A spark plug as set forth in claim 1 characterized in that the ground electrode carrier casing is of higher thermal conductivity than the spark plug casing.

5. A spark plug as set forth in claim 1 characterized in that the ground electrode carrier casing portion which in the position of installation of the spark plug faces towards a combustion chamber or the entire ground electrode carrier casing is in the form of a ring fitted onto or welded to the other ground electrode carrier casing portion or portions or the spark plug casing.

6. A spark plug as set forth in claim 1 characterized in that the ground electrode carrier casing portion which in the position of installation of the spark plug faces towards a combustion chamber or the ground electrode carrier casing carries a ground electrode or a ground electrode arrangement.

7. A spark plug as set forth in claim 6 characterized in that the ground electrode carrier casing portion which in the position of installation of the spark plug faces towards a combustion chamber or the ground electrode carrier casing is formed in one piece with the ground electrode.

8. A spark plug as set forth in claim 6 characterized in that the ground electrode or the ground electrode arrangement is arranged substantially in the interior of the ground electrode carrier casing portion which in the position of installation of the spark plug faces towards a combustion chamber, or of the ground electrode carrier casing.

9. A spark plug as set forth in claim 8 characterized in that the wall, surrounding the ground electrode, of the ground electrode carrier casing portion which in the position of installation of the spark plug faces towards a combustion chamber or of the ground electrode carrier casing is inclined at least in region-wise manner towards the ground electrode at an angle of between 10° and 60° relative to a line parallel to the central electrode of the spark plug.

10. A spark plug as set forth in claim 1 characterized in that the ground electrode carrier casing portion which in the position of installation of the spark plug faces towards a combustion chamber has a nickel-base alloy or a nickel-chromium alloy.

11. A spark plug as set forth in claim 10 characterized in that the nickel-chromium alloy, besides nickel and chromium, additionally has at least one of the elements aluminum, titanium, niobium, cobalt, copper, molybdenum, tungsten or iron.

12. A spark plug as set forth in claim 1 characterized in that it is suitable for use in internal combustion engines.

13. A process for the production of a spark plug comprising a spark plug casing and a ground electrode carrier casing characterized in that the ground electrode carrier casing is provided with at least two ground electrode carrier casing portions, wherein they are of different materials or the ground electrode carrier casing is made from a different material from the spark plug casing.

14. A process as set forth in claim 13 characterized in that on a commercially available spark plug comprising a ground electrode carrier casing at the end thereof which in the position of installation faces towards a combustion chamber a part of the ground electrode carrier casing or the entire ground electrode carrier casing and possibly the ground electrode or ground electrode arrangement present there is removed and then a ground electrode carrier ring is fitted onto or welded to the remaining part of the ground electrode carrier casing or the spark plug casing of the commercially available spark plug, wherein the ground electrode carrier ring is of a different material from the remaining part of the ground electrode carrier casing or the spark plug casing of the commercially available spark plug.

15. A process as set forth in claim 14 characterized in that the ground electrode carrier ring is welded by means of pulsed or unpulsed laser to the remaining part of the ground electrode carrier casing or the spark plug casing of the commercially available spark plug.
